(19) United States
(12) Patent Application Publication
(10) Pub. No.: US 2022/0288776 A1
(43) Pub. Date: Sep. 15, 2022

(54) METHOD AND A MEDIUM FOR COGGING COMPENSATING A MOTOR DRIVING SIGNAL

(71) Applicant: HALODI ROBOTICS AS, Moss (NO)

(72) Inventor: Brandon Thomas SHREWSBURY, Gulf Breeze, FL (US)

(21) Appl. No.: 17/635,881

(22) PCT Filed: Aug. 20, 2019
(86) PCT No.: PCT/EP2019/072279

§ 371 Date: Feb. 16, 2022

(51) Int. Cl. B25J 9/16; H02K 29/03; B25J 9/10; B25J 9/12

(52) U.S. Cl. CPC B25J 9/1653; H02K 29/03; B25J 9/1651; B25J 9/1633; B25J 9/163; B25J 9/102; B25J 9/126

(57) ABSTRACT

Given a method for driving an electric motor in a direct drive environment, it is an objective of the present invention to smoothen the effect of cogging torque. The objective is solved by the method comprising calibration steps: a) control the motor to run at a first velocity in a first direction and, while miming the motor in the first direction, measure first current values for a plurality of motor positions, the first current values indicating currents required to run the motor at the first velocity at each of the plurality of motor positions; b) control the motor to run at a second velocity in a second direction and, while running the motor in the second direction, measure second current values for the same plurality of motor positions as determined in step a), the second current values indicating currents required to run the motor at the second velocity at each of the plurality of motor positions; c) for each motor position of the plurality of motor positions, calculate an average of the first and the second current measurements to generate averaged current measurements values for the plurality of motor positions; and d) store a map between the plurality of motor positions and corresponding averaged current measurements values; the method further comprising motor driving steps: e) receive a desired driving current; f) receive a signal indicating a motor position at a present time; g) use the map to determine a delta current for the motor position at the present time; h) add the delta current to the desired driving current to generate a compensated driving current; and i) drive the motor using the compensated driving current.

The invention relates to a method and a computer-readable for cogging compensating a motor driving signal for an electric motor driving a robot joint or wheel in a direct drive environment according to claim 1 and claim 16 respectively.

When driving a robot with a direct driving motor, cogging torque in combination with the slow rotation speed of the motor might result in jerky, uneven motion. Direct drive and high torque density motors may rely on strong magnetic forces to generate sufficient torque. The strong magnetic forces may result in non- negligible cogging torques which degrades motor performance (current to torque ratio and linearity), in particular at low rotation speeds.

The deficiency identified in the art is solved by the method of claim 1 and the computer-readable medium of claim 16.

In particular, the deficiency is solved by a method for cogging compensating a driving signal for an electric motor in a direct drive environment, the method comprising calibration steps:
a) control the motor to run at a first velocity in a first direction and, while running the motor in the first direction, measure first current values for a plurality of motor positions, the first current values indicating currents required to run the motor at the first velocity at each of the plurality of motor positions;
b) control the motor to run at a second velocity in a second direction and, while running the motor in the second direction, measure second current values for the same plurality of motor positions as determined in step a), the second current values indicating currents required to run the motor at the second velocity at each of the plurality of motor positions;
c) for each motor position of the plurality of motor positions, calculate an average of the first and the second current measurements to generate averaged current measurements values for the plurality of motor positions;
d) store a map between the plurality of motor positions and corresponding averaged current measurements values;

the method further comprising motor driving steps:
e) receive a desired driving current;
f) receive a signal indicating a motor position at a present time;
g) use the map to determine a delta current for the motor position at the present time;
h) add the delta current to the desired driving current to generate a compensated driving current;
i) drive the motor using the compensated driving current.

Advantages include a smoother rotation speed of the direct drive, high torque motor, even if the motor is controlled in an open loop torque control manner. A desired motor torque may be translated into a desired motor current using a torque constant (Kt). In principle, the gained torque is linear with driving current. The disclosed method improves the linearity at low rotation speeds.

The motor controller tracks desired current and the motor has an absolute encoder and consistent cogging. The motor controller provides current for each coil in the motor, based on a desired motor current and/or desired motor torque. The current for each coil may depend on motor direction, desired current, number of pole pairs, and phase order.

The method may include controlling the rotation speed of the motor using a stiff position / velocity controller, measure motor current from a motor controller, and an absolute encoder to build a feedforward current model to cancel out the cogging torque.

Current at each motor position may be measured using an amp meter.

In one embodiment, the first velocity is identical to the second velocity and substantially constant;
wherein in step a), the motor is run at least a full rotation;
wherein in step b), the motor is run at least a full rotation;
wherein the motor comprises at least one position sensor to derive the position of the motor.

Advantages of the first and second velocity being of the same speed (in opposite directions) and substantially constant include facilitated calculations.
In one embodiment, the direct drive environment includes a using of the electric motor to drive a robot joint and/or a robot wheel with a gear ratio below 1:8, below 1:4, below 1:2 or preferably a gear ratio of 1:1, while maintaining a smooth rotation velocity.
In one embodiment, a well-tuned position / velocity controller, preferably a PD controller is used in step a) and/or in step b) to run the motor at substantial constant velocity along a triangular reference trajectory.
In one embodiment, a speed of running the motor in the first direction and in the second direction is preferably based on motor momentum and cogging force, and / or preferably lower than 0.5 rad/s.

In one embodiment, the driving current translates into a torque of the motor.

In one embodiment, the method is used to compensate for cogging torques in the motor.
In one embodiment, step a) and/or step b) is preferably carried out for a plurality of full rotations of the motor, preferably for from −7 to 7 radians in each direction.

Traveling over more than one full rotation ensures that when the trajectory changed direction the velocity and current loops have time to settle before traveling in the target areas. The target area is a full rotation positions of the motor for which current is measured.

Required current may also be measured for more than a full rotation. In this case, the multiple current levels measured for each position may be averaged in each direction to generate current levels for a full rotation (2*pi rad) in each direction.
In one embodiment, generate averaged current measurements values in step c) includes subsample and /or filter the averaged current measurements values,
In one embodiment, generate averaged current measurements values in step c) includes subsample averaged current measurements values to between 256 and 8192 sample points, preferably to 512 sample points.
In one embodiment, store a map in step d) preferably includes learn and/or create a look-up table, and
wherein use the map to determine a delta current for the motor position at the present time in step g) includes looking up at least one value in the look- up table.
In one embodiment, determine the current delta value in step f) includes an interpolation, preferably spline interpolation, polynomial interpolation, or linear interpolation between two or more values in the look-up table.
In one embodiment, the first current values of step a) and second current values of step b) are preferably filtered, preferably using zero phase filter, before calculating an average in step c).
In one embodiment, the number of the first current values and the number of the first current values for each rotation is above 32768, preferably 524288.
In one embodiment, the electric motor is a synchronous motor, preferably a brushless motor.

The deficiency is further solved by a computer-readable medium comprising instructions which, when executed by a computer, cause the computer to carry out the steps of the herein disclosed method.

The benefits and advantages of the computer-readable medium are equal or similar to the advantages of the above-mentioned method.

In the following, embodiments of the invention are described with respect to the figures, wherein

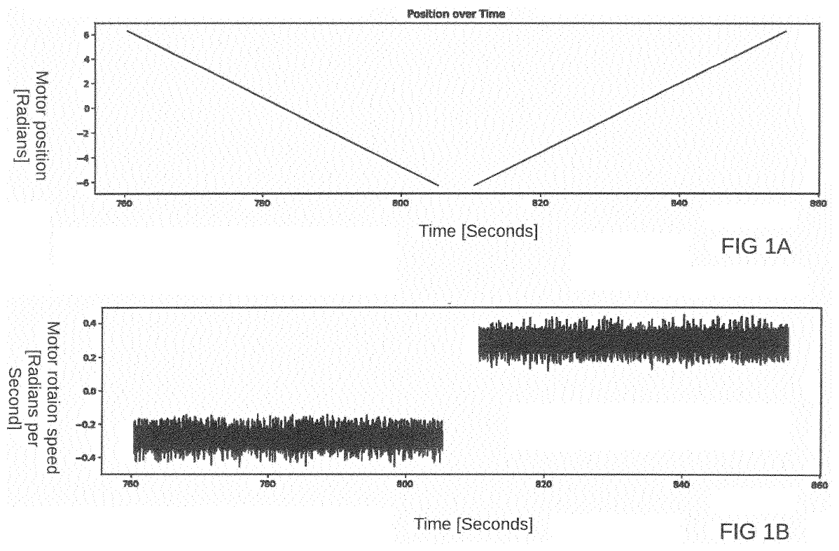

FIG. 1 shows a triangular reference trajectory for driving a motor and corresponding substantially constant velocity in a first direction and a second direction;

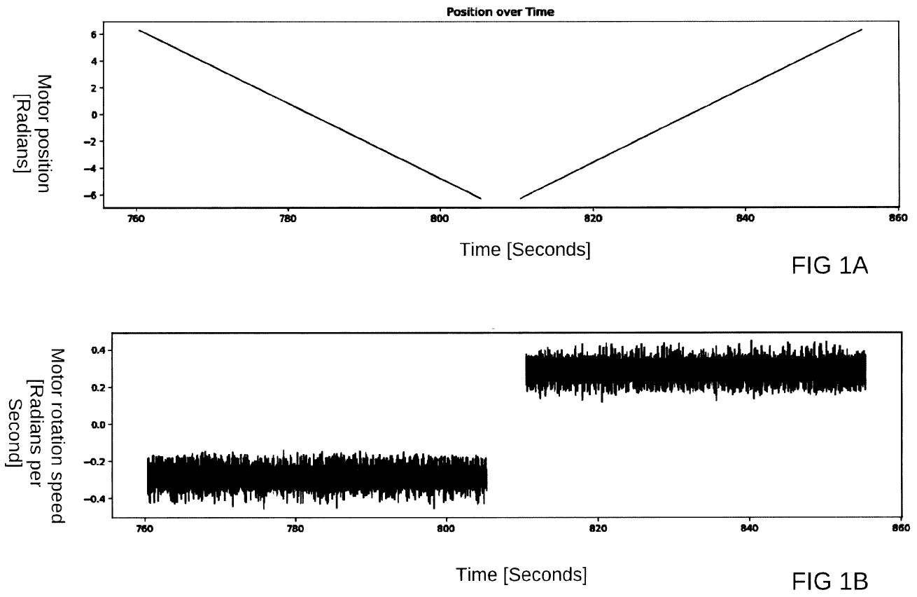

FIG. 2 shows measurement of currents in a first and in a second direction for a full rotation of the motor;

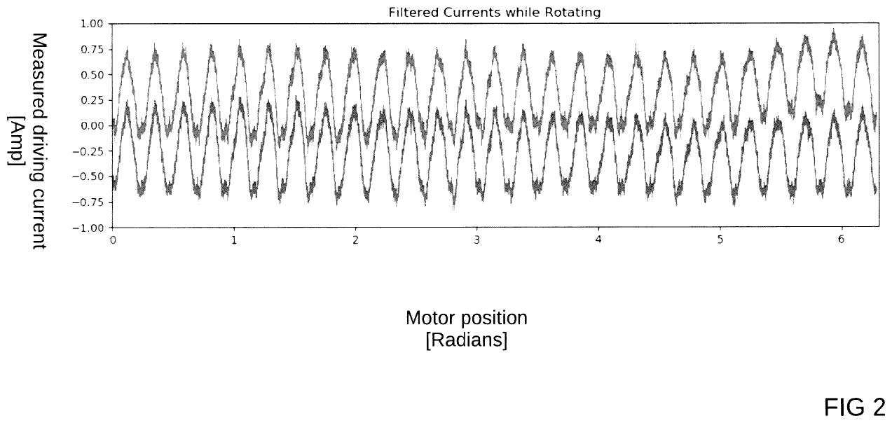

FIG. 3 depicts filtering of measured current while rotating a motor;

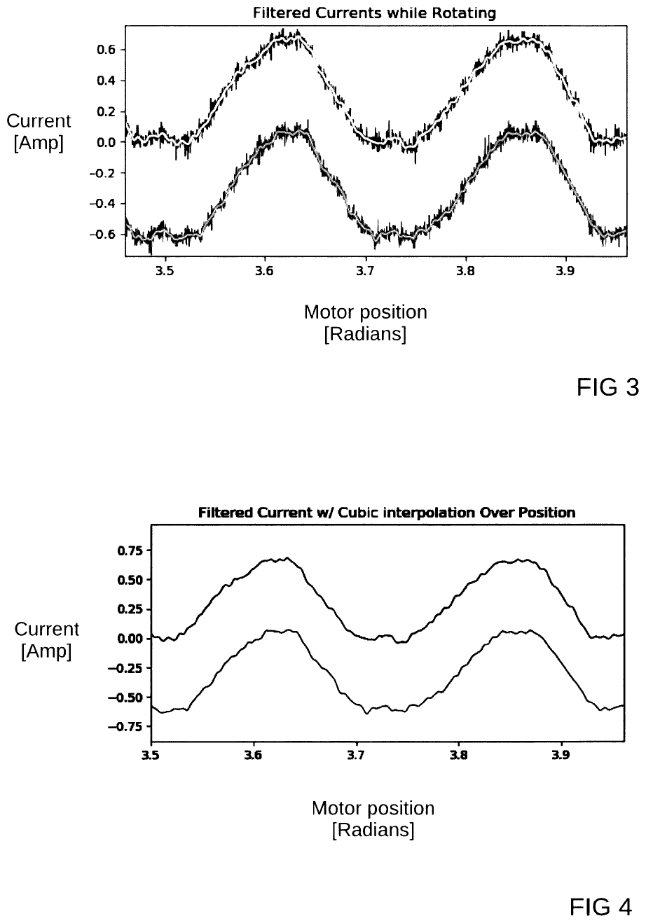

FIG. 4 depicts cubic interpolated filtered current measurement in a first and a second direction;

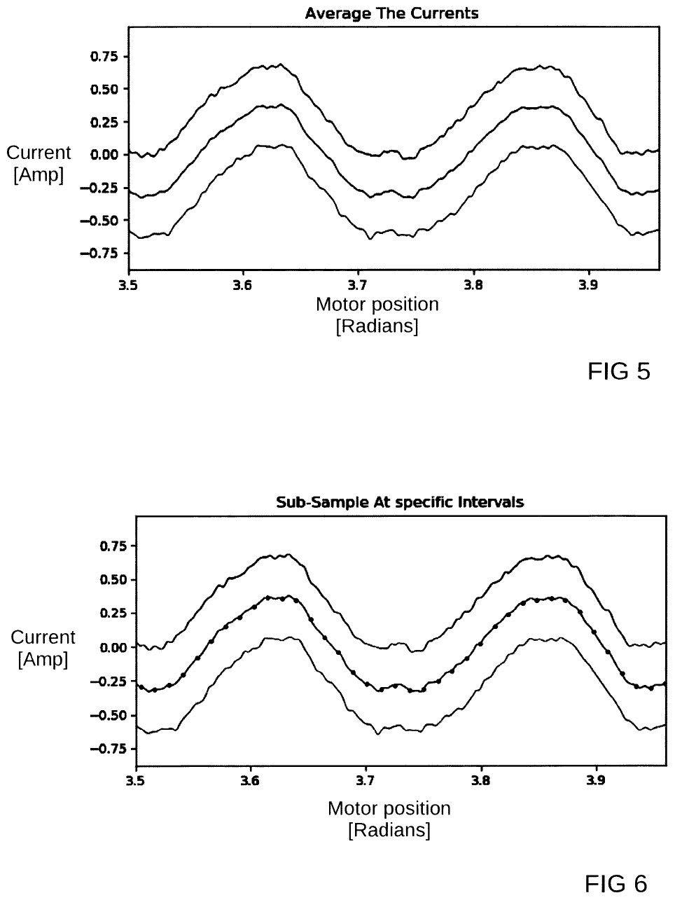

FIG. 5 depicts current measurement data including average for each motor position;

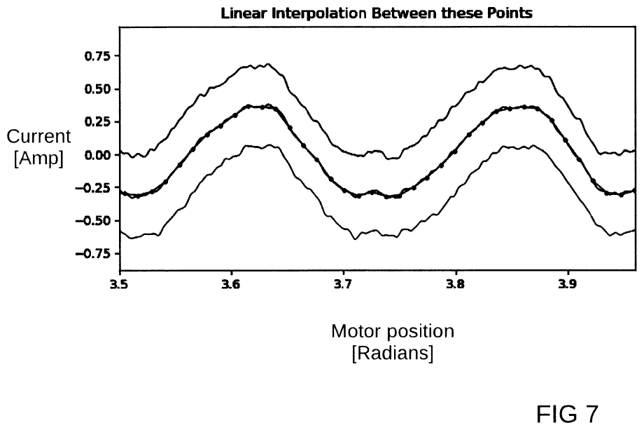

FIG. 6 depicts sub-sampling of averaged current measurement data;

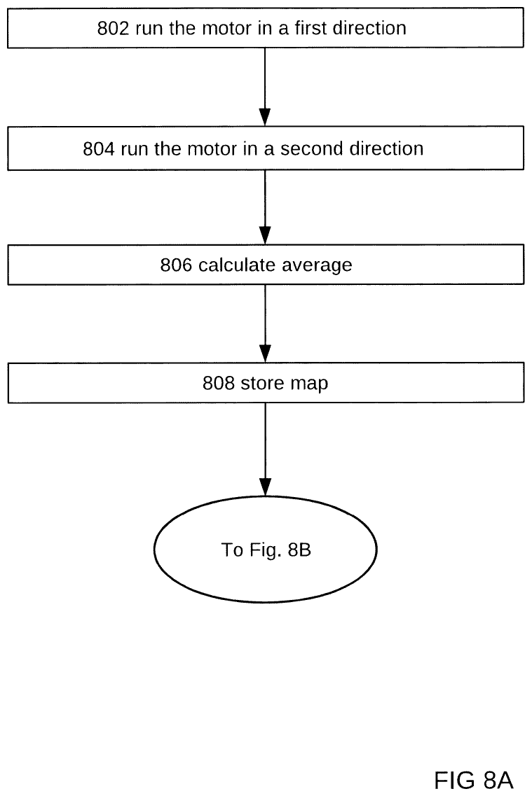

FIG. 7 depicts Linear interpolation between sub-sampled current measurement data;

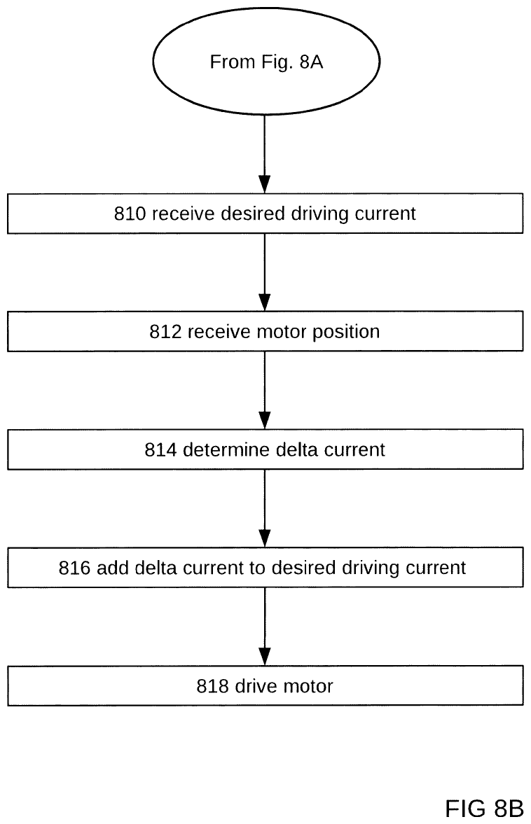

FIG. 8 depicts method steps for smoothly driving an electric motor in a direct drive environment.

Cogging torque in an electric motor is an internal motor torque generated by the interaction between the permanent magnets of the rotor and the stator slots. Depending on the rotational position of the rotor, the distance between the magnets and the stator slots, and so the magnetic force and the corresponding torque varies. The Cogging torque is therefore varying with the rotational position of the rotor compared to the stator.

The cogging torque magnitude dependence on the rotational position of the rotor is dependent on several factors, including the number and strength of magnets and the number of stator slots.

Cogging torque in electric motors may be known, but in the field of humanoid robotics, cogging torque is generally not problematic due to the high rotation speed of the motor, and the high gear ratio of driving the robot, rendering the impact of the cogging torque on the movement of the robot negligible.

The present disclosure relates to a direct (or with low gear ratio) drive motor for driving humanoid robot joints or wheels. In such direct drive setting, the cogging torque may have an impact on the movement of the robot and result in jerky movements of joints of wheels. An example of a high torque, direct drive, humanoid robot motor is described in WO 2018/149499 A1.

The impact cogging torque could be addressed by using feedback signals from a rotor position sensor and a control loop to adjust for any jerky movements. Such control may have to operate at high sample rate and may need a complex implementation to take into consideration the current operation of the motor. Further, the motor is controlled by the current flowing through the motor, and alternating the current at high speed may lead to undesirable AC effects.

The control of the motor is further facilitated if the motor torque is linear (first order) with input current, and independent of motor position.

The present disclosure relates to a feed forward of cogging compensation current in order to achieve smooth operation humanoid robot joints or wheels driven with direct drive motor. The feed forward of cogging compensation may be in the form of a look-up table, where the amount of compensation current can be read based on a known rotor position.

A feed forward model may be generated by first spin the motor with a stiff velocity controller and an absolute encoder. The motor is controlled to travel through the entire range of motor orientations in both directions at the same speed. The measured currents in the both directions may then be are averaged. Based on the averaged current, a lookup table may be built and to used as a feedforward current term to compensate for cogging torque.

A position and/or velocity controller may be used to run the motor at a slow constant speed. This may be accomplished by using a PD Controller and by ensuring that the gains are tuned to provide as little noise in the sensed velocity and while at the same time making sure that the motor's static friction and cogging torques is overcome.

FIG. 1A shows a reference trajectory for rotor positions for a time period indicated as from time 760 to time 860. During a first part of the period (from time 760 to time 805) the reference position trajectory has a time dependence that indicate a desired change of position for rotor in a first direction. During a second part of the period (from time 810 to time 855), the reference position trajectory has a time dependence that indicate a desired change of rotational position of the rotor in a second direction.

FIG. 1B shows the corresponding velocity of the rotor achieved by the controller. As can be seen, the controller is constantly adjusting the current in order to track the reference trajectory. A triangular reference trajectory is preferably used for the desired motor position with constant velocity as input. A preferable trajectory may span from −7 radians to 7 radians with a 0.3 Rad/s desired velocity. The desired velocity may be held low in order to reduce viscous damping.

Traveling 7 radians (slightly more than a single rotation) may be important in order for the velocity and current loops to settle after the trajectory changed direction, before traveling in the target areas. Control gains can be unpractically high as long as the velocity signal is smooth.

FIG. 2 shows measurement of currents in a first and in a second direction for motor orientation over a full rotation measurement target area (0 to 2pi rad.). The cogging torque relates to the interaction between the permanent magnets of the rotor and the stator slots. As seen, the cogging torque is position dependent and a periodicity can be seen. The periodicity of current measurement in both directions are in phase, while a cogging torque that acts positive on the average current (in absolute terms) in the first direction, will act negative in the second direction, and vice versa. The cogging torque periodicity may depend on the number of magnetic poles and the number of teeth on the stator (stator slots).

The motor is preferably run at low or with no external load. The DC value of the signal in FIG. 2 may represent the kinetic friction in the motor run in a first and a second direction.

FIGS. 3 to 7 depicts current measurement values zoomed in over two cogging torque cycles (from 3.5 to 3.95 radians). FIG. 3 shows filtering of measured current while rotating a motor. The measured current values in the first and second direction may be filtered using a zero phase filter. FIG. 4 depicts cubic interpolated filtered current measurement in a first and a second direction.

The two filtered current signals in a first and a second direction may represent the cogging torques, viscous damping and coulomb frictions, along with other real-world imperfections. Assuming the viscous damping, coulomb friction, bearing friction and other known or unknowns imperfections are symmetric with respect to motor direction, averaging the two signals retains the currents required to overcome the cogging torque. FIG. 5 shows current measurement data including averaged measurement for a plurality of motor positions.

The averaged measured current signal can be subsampled, filtered, learned, or exported directly to a lookup table. Depending on the number of magnets and stator slots in the motor, a preferable subsample of the average measurement data may be 512 points for a lookup table. FIG. 6 shows sub-sampling of averaged current measurement data. Compensation current may then be read from the look-up table based on a current orientation of the motor. When reading the compensation current from the look-up table, a linear interpolation may be performed between the points to achieve an effective results. FIG. 7 shows linear interpolation between sub-sampled current measurement data that might be read from a look-up table. The look-up table allows an open loop torque control of motor.

Since temperature might have an impact on cogging torque, the look-up table may be generated for a plurality of motor, magnet, and/or stator temperatures to further improve the precision of the cogging compensation at different motor, magnet, and/or stator temperatures.

When the motor spins over a certain rotation speed, the controller may not be able to correctly compensate for cogging torque. A solution might be to decrease, or turn off, the cogging compensation, as the rotation speed of the motor increases. The cogging torque may primarily be an issue at low rotation speeds.

FIGS. 8A and 8B show method steps for smoothly driving an electrical motor in a direct drive environment. The steps include a) control 802 the motor to run at a first velocity in a first direction and, while running the motor in the first direction, measure first current values for a plurality of motor positions, the first current values indicating currents required to run the motor at the first velocity at each of the plurality of motor positions; b) control 204 the motor to run at a second velocity in a second direction and, while running the motor in the second direction, measure second current values for the same plurality of motor positions as determined in step a), the second current values indicating currents required to run the motor at the second velocity at each of the plurality of motor positions; c) for each motor position of the plurality of motor positions, calculate 806 an average of the first and the second current measurements to generate averaged current measurements values for the plurality of motor positions; d) store 808 a map between the plurality of motor positions and corresponding averaged current measurements values.

The steps may further include e) receive 810 a desired driving current; f) receive 812 a signal indicating a motor position at a present time; g) use 814 the map to determine a delta current for the motor position at the present time; h) add 816 the delta current to the desired driving current to generate a compensated driving current; and i) drive 818 the motor using the compensated driving current.

The above described method allows to take an input current for driving the motor (corresponding to a desired motor torque), and a known rotor position of the motor at a present time, and instantaneously adjust for the cogging torque at each point generating a smooth movement of the robot limbs and/or wheels. The torque to input current ratio is substantially independent of rotor position.

Due to slight difference in each motor, a cogging compensation table as described herein may be generated for each motor as a step during manufacturing. The cogging compensation may also be performed at certain intervals to address aging of the motor, or in response to certain performance degrades or failure in the motor (i.e. jerky movements of limbs or wheels).

1. A method for cogging compensating a driving signal for an electric motor in a direct drive environment, the method comprising calibration steps:
a) control the motor to run at a first velocity in a first direction and, while running the motor in the first direction, measure first current values for a plurality of motor positions, the first current values indicating currents required to run the motor at the first velocity at each of the plurality of motor positions;
b) control the motor to run at a second velocity in a second direction and, while running the motor in the second direction, measure second current values for the same plurality of motor positions as determined in step a), the second current values indicating currents required to run the motor at the second velocity at each of the plurality of motor positions;
c) for each motor position of the plurality of motor positions, calculate an average of the first and the second current measurements to generate averaged current measurements values for the plurality of motor positions; and
d) store a map between the plurality of motor positions and corresponding averaged current measurements values;
the method further comprising motor driving steps:
e) receive a desired driving current;
f) receive a signal indicating a motor position at a present time;
g) use the map to determine a delta current for the motor position at the present time;
h) add the delta current to the desired driving current to generate a compensated driving current; and
i) drive the motor using the compensated driving current.

2. The method of claim 1,
wherein the first velocity is identical to the second velocity and substantially constant;
wherein in step a), the motor is run at least a full rotation;
wherein in step b), the motor is run at least a full rotation;
wherein the motor comprises at least one position sensor to derive the position of the motor.

3. The method of claim 1,
wherein the direct drive environment includes a using of the electric motor to drive a robot joint and/or a robot wheel with a gear ratio below 1:8, below 1:4, below 1:2 or preferably a gear ratio of 1:1, while maintaining a smooth rotation velocity.

4. The method of claim 1,
wherein a well-tuned position / velocity controller, preferably a PD controller is used in step a) and/or in step b) to run the motor at substantial constant velocity along a triangular reference trajectory.

5. The method of claim 1,
wherein a speed of running the motor in the first direction and in the second direction is preferably based on motor momentum and cogging force, and / or preferably lower than 0.5 rad/s.

6. The method of claim 1,
wherein the driving current translates into a torque of the motor.

7. The method of claim 1,
wherein the method is used to compensate for cogging torques in the motor.

8. The method of claim 1,
wherein step a) and/or step b) is preferably carried out for a plurality of full rotations of the motor, preferably for 7 radians in each direction.

9. The method of claim 1,
wherein generate averaged current measurements values in step c) includes subsample and /or filter the averaged current measurements values.

10. The method of claim 1,
wherein generate averaged current measurements values in step c) includes subsample averaged current measurements values to between 256 and 8192 sample points, preferably to 512 sample points.

11. The method of claim 1,
wherein store a map in step d) preferably includes learn and/or create a look-up table, and
wherein use the map to determine a delta current for the motor position at the present time in step g) includes looking up at least one value in the look-up table.

12. The method of claim 11,
wherein use the map to determine a delta current for the motor position at the present time in step g) includes an interpolation, preferably spline interpolation, polynomial interpolation, or linear interpolation between two or more values in the look-up table.

13. The method of claim 1,
wherein the first current values of step a) and second current values of step b) are preferably filtered, preferably using zero phase filter, before calculating an average in step c).

14. The method of claim 1,
wherein the number of the first current values and the number of the first current values for each rotation is above 32768, preferably 524288.

15. The method of claim 1,
wherein the electric motor is a synchronous motor, preferably a brushless motor.

16. A computer-readable medium comprising instructions which, when executed by a computer, cause the computer to carry out the steps of the method of claim 1.
